(19) United States
(12) Patent Application Publication
(10) Pub. No.: US 2021/0214560 A1
(43) Pub. Date: Jul. 15, 2021

(54) COMPOUND, COLORING COMPOSITION, INK, TONER, COLORING RESIN COMPOSITION, AND COMPOSITION FOR DYEING FIBER

(71) Applicant: FUJIFILM Corporation, Tokyo (JP)

(72) Inventors: Yoshihiko FUJIE, Fujinomiya-shi (JP); Masatoshi MIZUMURA, Fujinomiya-shi (JP); Motoki UEDA, Fujinomiya-shi (JP)

(73) Assignee: FUJIFILM Corporation, Tokyo (JP)

(21) Appl. No.: 17/211,854

(22) Filed: Mar. 25, 2021

Related U.S. Application Data
(63) Continuation of application No. PCT/JP2019/037378, filed on Sep. 24, 2019.

(30) Foreign Application Priority Data
Sep. 26, 2018 (JP) 2018-180576
Mar. 26, 2019 (JP) 2019-059182

(51) Int. Cl. C09B 31/14; C09B 29/095; C09D 11/037; C09D 11/328; D06P 1/04; G03G 9/09

(52) U.S. Cl. CPC C09B 31/14; C09B 29/095; C09D 11/037; D06P 3/52; D06P 1/04; G03G 9/091; C09D 11/328

(57) ABSTRACT

A compound represented by the Formula (1), in which, in the Formula (1), R¹ and R² each independently represent an alkyl group having 1 to 12 carbon atoms, and the alkyl group having 1 to 12 carbon atoms may have a substituent; R³ represents a halogen atom, a nitro group, a cyano group, an alkoxycarbonyl group having 2 to 12 carbon atoms, or an acyl group having 2 to 12 carbon atoms; and R¹ and R² may be bonded to each other to form a ring, is provided.

### CROSS REFERENCE TO RELATED APPLICATION

This is a continuation of International Application No. PCT/JP2019/037378 filed on Sep. 24, 2019, and claims priorities from Japanese Patent Application No. 2018-180576 filed on Sep. 26, 2018 and Japanese Patent Application No. 2019-059182 filed on Mar. 26, 2019, the entire disclosures of which are incorporated herein by reference.

### BACKGROUND OF THE INVENTION

### 1. Field of the Invention

The present invention relates to a compound, a coloring composition, an ink, a toner, a coloring resin composition, and a composition for dyeing a fiber.

### 2. Description of the Related Art

Color Index (C. I.) Solvent Black 3 (hereinafter, also referred to as “Solvent Black 3”) developed around the beginning of the 20th century is an oil-soluble black disazo compound commonly called as “Sudan Black B”.

In 1934, as a method of fat staining, that is, as a proving method of lipids in blood cells and tissues, Lison et al. published a method for staining blood cells and tissues fat using a fat-soluble (oil-soluble) coloring agent, which utilizes the property that the coloring agent dissolves in lipids, and the method is still widely used today as a method for staining Sudan Black B (Histochemistry, vol. 54, p. 27 to 37).

In 1952, Berman et al. published the chemical structural formula of Solvent Black 3 (Histochemistry, vol. 54, p. 237 to 250), and since then, applications to various industrial fields such as inkjet ink, toner, oil coloring, writing instrument, textile dyeing, and leather dyeing have been proposed (for example, JP1980-025463A (JP-555-025463A), JP1975-139745A (JP-550-139745A), British Patent No. 1029182, JP1978-014896A (JP-553-014896A), US3679454A, JP1974-020054B (JP-549-020054B), and JP1989-044218B (JP-H01-044218B)).

As described above, Solvent Black 3 is currently positioned as an industrially important oil-soluble black dye.

In addition, JP2015-044993A and CN1546575C disclose disazo compounds different from Solvent Black 3.

### SUMMARY OF THE INVENTION

However, Solvent Black 3 has an issue of being inferior in stability to heat. That is, Solvent Black 3 has various problems due to the decomposition of dye in the usage conditions for various purposes and the production conditions thereof, and improvement thereof has been desired.

An object of the present invention is to provide a compound which can be used as an oil-soluble black dye and has more excellent stability to heat than Solvent Black 3; a coloring composition, an ink, a toner, a coloring resin composition, and a composition for dyeing a fiber, which contain the compound; and an intermediate useful for a production of the compound.

The present inventors have conducted extensive studies, and have found that the above-described objects can be achieved by the following methods.

The reason why the compound represented by Formula (1) according to an aspect of the present invention has more excellent stability to heat than Solvent Black 3 has not been clarified, but it is presumed by the present inventors as follows.

The compound represented by Formula (1) according to the aspect of the present invention has, at an ortho position (R³) to the azo group, a halogen atom, a nitro group, a cyano group, an alkoxycarbonyl group having 2 to 12 carbon atoms, or an acyl group having 2 to 12 carbon atoms. Since these groups interact with the azo group in Formula (1) (halogen bond and the like) or sterically protect the azo group, it is considered that the heat stability of the compound represented by Formula (1) is significantly improved as compared with Solvent Black 3.

In addition, the reason why the compound represented by Formula (3) according to an aspect of the present invention has more excellent stability to heat than Solvent Black 3 is presumed as follows.

The compound represented by Formula (3) according to the aspect of the present invention has, at an ortho position (R¹³) to the azo group, a halogen atom, a nitro group, a cyano group, an alkoxycarbonyl group having 2 to 12 carbon atoms, or an acyl group having 2 to 12 carbon atoms. Since these groups interact with the azo group in Formula (3) (halogen bond and the like) or sterically protect the azo group, it is considered that the heat stability of the compound represented by Formula (3) is significantly improved as compared with Solvent Black 3.

Furthermore, the compound represented by Formula (3) has an amino group (—NH—) at an ortho position to the other azo group. As a result, the azo group and the amino group form a hydrogen bond, and it is considered that the heat stability of the compound represented by Formula (3) is further improved.

<1> A compound represented by the following Formula (1),

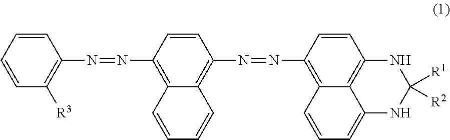

in which, in the Formula (1), R¹ and R² each independently represent an alkyl group having 1 to 12 carbon atoms, and the alkyl group having 1 to 12 carbon atoms may have a substituent; R³ represents a halogen atom, a nitro group, a cyano group, an alkoxycarbonyl group having 2 to 12 carbon atoms, or an acyl group having 2 to 12 carbon atoms; and R¹ and R² may be bonded to each other to form a ring.

<2> The compound according to <1>,

in which R¹ and R² each independently represent the alkyl group having 1 to 12 carbon atoms, the alkyl group being unsubstituted, or substituted with a hydroxyl group, an alkylcarbonyloxy group, or an alkylaminocarbonyloxy group.

<3> The compound according to <1> or <2>,

in which R¹ and R² are different from each other.

<4> The compound according to any one of <1> to <3>,

in which R³ represents a fluorine atom, a chlorine atom, a nitro group, a cyano group, or an acyl group having 2 to 12 carbon atoms.

<5> A compound represented by the following Formula (3),

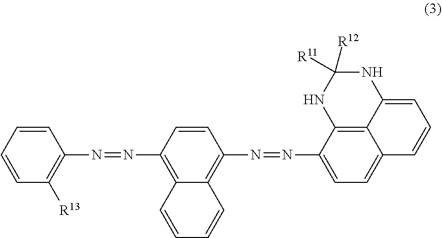

in which, in the Formula (3), R¹¹ and R¹² each independently represent an alkyl group having 1 to 12 carbon atoms, and the alkyl group having 1 to 12 carbon atoms may have a substituent; R¹³ represents a halogen atom, a nitro group, a cyano group, an alkoxycarbonyl group having 2 to 12 carbon atoms, or an acyl group having 2 to 12 carbon atoms; and R¹¹ and R¹² may be bonded to each other to form a ring.

<6> The compound according to <5>,

in which R¹¹ and R¹² each independently represent the alkyl group having 1 to 12 carbon atoms, the alkyl group being unsubstituted, or substituted with a hydroxyl group, an alkylcarbonyloxy group, or an alkylaminocarbonyloxy group.

<7> The compound according to <5> or <6>,

in which and R¹² are different from each other.

<8> The compound according to any one of <5> to <7>,

in which R¹³ represents a fluorine atom, a chlorine atom, a nitro group, a cyano group, or an acyl group having 2 to 12 carbon atoms.

<9> A coloring composition comprising:

the compound according to any one of <1> to <8>.

<10> The coloring composition according to <9>,

in which the coloring composition contains the compound according to any one of <1> to <4> and the compound according to any one of <5> to <8>.

<11> An ink comprising:

the compound according to any one of <1> to <8>; or

the coloring composition according to <9> or <10>.

<12> A toner comprising:

the compound according to any one of <1> to <8>; or

the coloring composition according to <9> or <10>.

<13> A coloring resin composition comprising:

the compound according to any one of <1> to <8>; or

the coloring composition according to <9> or <10>.

<14> A composition for dyeing a fiber, comprising:

the compound according to any one of <1> to <8>; or

the coloring composition according to <9> or <10>.

<15> A compound represented by the following Formula (2),

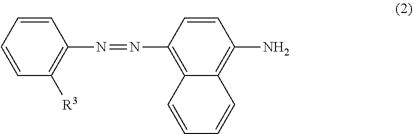

in which, in the Formula (2), R³ represents a halogen atom, a nitro group, a cyano group, an alkoxycarbonyl group having 2 to 12 carbon atoms, or an acyl group having 2 to 12 carbon atoms.

According to the present invention, it is possible to provide a compound which can be used as an oil-soluble black dye and has more excellent stability to heat than Solvent Black 3; a coloring composition, an ink, a toner, a coloring resin composition, and a composition for dyeing a fiber, which contain the compound; and an intermediate useful for a production of the compound.

### BRIEF DESCRIPTION OF THE DRAWINGS

FIG. 1 is a diagram showing a ¹H-nuclear magnetic resonance (NMR) spectrum (in deuterated chloroform) of a compound (1-3).

FIG. 2 is a diagram showing an absorption spectrum of a compound (1-36) in a dilute solution of tetrahydrofuran.

FIG. 3 is a diagram showing a reflection spectrum of a dyed cloth obtained in Example 26.

### DESCRIPTION OF THE PREFERRED EMBODIMENTS

Hereinafter, the present invention will be described in detail.

In the present specification, the numerical value range expressed by “to” means that the numerical values described before and after “to” are included as a lower limit value and an upper limit value, respectively.

In the present specification, “(meth)acrylate” represents at least one of acrylate or methacrylate, “(meth)acryl” represents at least one of acryl or methacryl, and “(meth)acryloyl” represents at least one of acryloyl or methacryloyl.

[Compound Represented by Formula (1)]

A compound represented by Formula (1) according to an embodiment of the present invention will be described.

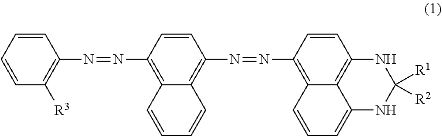

In Formula (1), R¹ and R² each independently represent an alkyl group having 1 to 12 carbon atoms, which may have a substituent, R³ represents a halogen atom, a nitro group, a cyano group, an alkoxycarbonyl group having 2 to 12 carbon atoms, or an acyl group having 2 to 12 carbon atoms, and R¹ and R² may be bonded to each other to form a ring.

In Formula (1), R¹ and R² each independently represent an alkyl group having 1 to 12 carbon atoms, which may have a substituent.

The alkyl group represented by R¹ and R² may be linear or branched.

The number of carbon atoms in the alkyl group represented by R¹ and R² is 1 to 12, preferably 1 to 8 and more preferably 1 to 5.

The alkyl group represented by R¹ and R² may have a substituent, and the substituent is not particularly limited. Examples thereof include a hydroxyl group, an alkylcarbonyloxy group (preferably, an alkylcarbonyloxy group having 2 to 8 carbon atoms), an alkylaminocarbonyloxy group (preferably, an alkylaminocarbonyloxy group having 2 to 8 carbon atoms), a cyano group, a carbamoyl group, an alkylcarbamoyl group (preferably, an alkylcarbamoyl group having 2 to 8 carbon atoms), an arylcarbamoyl group (preferably, an arylcarbamoyl group having 7 to 11 carbon atoms, and more preferably, a phenylcarbamoyl group), and an aryl group (preferably, an aryl group having 6 to 10 carbon atoms, and more preferably, a phenyl group).

It is preferable that the alkyl group represented by R¹ and R² has no substituent (that is, is an unsubstituted alkyl group).

R¹ and R² may be bonded to each other to form a ring.

In a case where R¹ and R² are bonded to each other to form a ring, R¹ and R² form an alkylene group. The number of carbon atoms in this alkylene group is preferably 2 to 12 and more preferably 2 to 8. This alkylene group may have a substituent, and the substituent is not particularly limited. Examples thereof include those groups described above as the substituent which may be included in the alkyl group.

From the viewpoint of the stability to heat, R¹ and R² preferably represent an unsubstituted alkyl group having 1 to 12 carbon atoms, or an alkyl group having 1 to 12 carbon atoms, which has, as a substituent, a hydroxyl group, an alkylcarbonyloxy group, or an alkylaminocarbonyloxy group. Furthermore, from the viewpoint of solubility and production cost, R¹ and R² more preferably represent an unsubstituted alkyl group having 1 to 12 carbon atoms, still more preferably represent an unsubstituted alkyl group having 1 to 8 carbon atoms, and particularly preferably represent an unsubstituted alkyl group having 1 to 5 carbon atoms.

Furthermore, from the viewpoint of solubility, it is particularly preferable that R¹ and R² are different from each other.

R³ in Formula (1) represents a halogen atom, a nitro group, a cyano group, an alkoxycarbonyl group having 2 to 12 carbon atoms, or an acyl group having 2 to 12 carbon atoms.

In a case where R³ represents a halogen atom, examples thereof include a fluorine atom, a chlorine atom, a bromine atom, and an iodine atom, and a fluorine atom or a chlorine atom is preferable and a chlorine atom is more preferable.

In a case where R³ represents an alkoxycarbonyl group having 2 to 12 carbon atoms, an alkoxycarbonyl group having 2 to 8 carbon atoms is preferable and an alkoxycarbonyl group having 2 to 5 carbon atoms is more preferable.

In a case where R³ represents an acyl group having 2 to 12 carbon atoms, an acyl group having 2 to 8 carbon atoms is preferable and an acyl group having 2 to 5 carbon atoms is more preferable. In addition, examples of the acyl group having 2 to 12 carbon atoms include an alkylcarbonyl group having 2 to 12 carbon atoms and an arylcarbonyl group having 6 to 12 carbon atoms (for example, a benzoyl group and the like), and an alkylcarbonyl group having 2 to 12 carbon atoms is preferable.

From the viewpoint of heat resistance, R³ is preferably a fluorine atom, a chlorine atom, a nitro group, a cyano group, an alkoxycarbonyl group having 2 to 12 carbon atoms, or an acyl group having 2 to 12 carbon atoms, more preferably a fluorine atom, a chlorine atom, a nitro group, a cyano group, or an acyl group having 2 to 12 carbon atoms, still more preferably a fluorine atom, a chlorine atom, a nitro group, a cyano group, or an alkylcarbonyl group having 2 to 12 carbon atoms, particularly preferably a chlorine atom, a cyano group, a nitro group, or an alkylcarbonyl group having 2 to 5, and most preferably a chlorine atom, a nitro group, a cyano group, or an acetyl group.

Specific examples of the compound represented by Formula (1) are shown below, but the present invention is not limited thereto. Compounds (1-25) to (1-30), and (1-52) are compounds in which R¹ and R² in Formula (1) are bonded to each other to form a ring. Ph represents a phenyl group.

TABLE 1

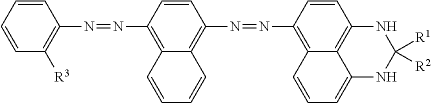

| Compound | R¹ | R² | R³ |
|---|---|---|---|
| (1-1) | —CH₃ | —CH₃ | —Cl |
| (1-2) | —C₂H₅ | —CH₃ | —Cl |
| (1-3) | —(CH₂)₂CH₃ | —CH₃ | —Cl |
| (1-4) | —CH(CH₃)₂ | —CH₃ | —Cl |
| (1-5) | —(CH₂)₃CH₃ | —CH₃ | —Cl |
| (1-6) | —CH₂CH(CH₃)₂ | —CH₃ | —Cl |
| (1-7) | —CH(CH₃)CH₂CH₃ | —CH₃ | —Cl |
| (1-8) | —C(CH₃)₃ | —CH₃ | —Cl |
| (1-9) | —(CH₂)₄CH₃ | —CH₃ | —Cl |
| (1-10) | —(CH₂)₂CH(CH₃)₂ | —CH₃ | —Cl |
| (1-11) | —(CH₂)₅CH₃ | —CH₃ | —Cl |
| (1-12) | —(CH₂)₇CH₃ | —CH₃ | —Cl |
| (1-13) | —(CH₂)₉CH₃ | —CH₃ | —Cl |
| (1-14) | —(CH₂)₁₁CH₃ | —CH₃ | —Cl |
| (1-15) | —C₂H₅ | —C₂H₅ | —Cl |

TABLE 2

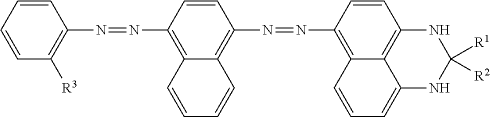

| Compound | R¹ | R² | R³ |
|---|---|---|---|
| (1-16) | —CH₂CH(CH₃)₂ | —CH₂CH(CH₃)₂ | —Cl |
| (1-17) | —CH₂OH | —CH₃ | —Cl |
| (1-18) | —CH₂OCOCH₃ | —CH₃ | —Cl |
| (1-19) | —CH₂OCOCH(CH₃)₂ | —CH₃ | —Cl |
| (1-20) | —CH₂OCOCH(C₂H₅)CH₂CH₂CH₂CH₃ | —CH₃ | —Cl |
| (1-21) | —CH₂OCONHCH(CH₃)₂ | —CH₃ | —Cl |
| (1-22) | —CH₂OH | —CH₂OH | —Cl |
| (1-23) | —CH₂OCOCH₃ | —CH₂OCOCH₃ | —Cl |
| (1-24) | —CH₂OCOCH(CH₃)₂ | —CH₂OCOCH(CH₃)₂ | —Cl |

| | | |
|---|---|---|
| (1-25) | —(CH₂)₄— | —Cl |
| (1-26) | —(CH₂)₅— | —Cl |
| (1-27) | —CH(CH₃)CH₂CH₂CH₂CH₂— | —Cl |
| (1-28) | —CH₂CH(CH₃)CH₂CH₂CH₂— | —Cl |
| (1-29) | —CH₂CH₂CH(OH)CH₂CH₂— | —Cl |
| (1-30) | —CH₂CH₂CH(OCOCH₃)CH₂CH₂— | —Cl |

TABLE 3

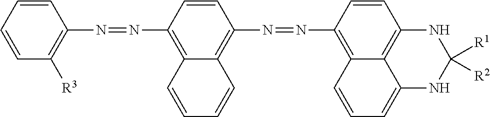

| Compound | R¹ | R² | R³ |
|---|---|---|---|
| (1-31) | —CH₃ | —CH₃ | —F |
| (1-32) | —C₂H₅ | —CH₃ | —F |
| (1-33) | —(CH₂)₄CH₃ | —CH₃ | —F |
| (1-34) | —CH₃ | —CH₃ | —Br |
| (1-35) | —C₂H₅ | —CH₃ | —Br |
| (1-36) | —CH₃ | —CH₃ | —NO₂ |
| (1-37) | —C₂H₅ | —CH₃ | —NO₂ |
| (1-38) | —CH₃ | —CH₃ | —CN |
| (1-39) | —C₂H₅ | —CH₃ | —CN |
| (1-40) | —CH₃ | —CH₃ | —CO₂CH₃ |
| (1-41) | —C₂H₅ | —CH₃ | —CO₂CH₃ |
| (1-42) | —(CH₂)₄CH₃ | —CH₃ | —CO₂CH₃ |
| (1-43) | —CH₃ | —CH₃ | —CO₂C₂H₅ |
| (1-44) | —CH₃ | —CH₃ | —CO₂CH(CH₃)₂ |
| (1-45) | —CH₃ | —CH₃ | —CO₂(CH₂)₃CH₃ |

TABLE 4

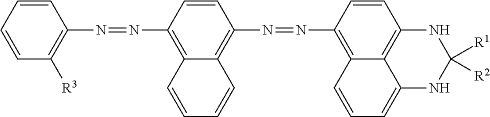

| Compound | R¹ | R² | R³ |
|---|---|---|---|
| (1-46) | —CH₃ | —CH₃ | —CO₂(CH₂)₇CH₃ |
| (1-47) | —CH₃ | —CH₃ | —CO₂(CH₂)₁₀CH₃ |
| (1-48) | —CH₃ | —CH₃ | —COCH₃ |
| (1-49) | —C₂H₅ | —CH₃ | —COCH₃ |
| (1-50) | —(CH₂)₄CH₃ | —CH₃ | —COCH₃ |
| (1-51) | —CH₂CH(CH₃)₂ | —CH₂CH(CH₃)₂ | —COCH₃ |
| (1-52) | —CH(CH₃)CH₂CH₂CH₂CH₂— | | —COCH₃ |
| (1-53) | —CH₂OH | —CH₃ | —COCH₃ |
| (1-54) | —CH₂OCOCH(C₂H₅)CH₂CH₂CH₂CH₃ | —CH₃ | —COCH₃ |
| (1-55) | —CH₂OH | —CH₂OH | —COCH₃ |
| (1-56) | —CH₂OCOCH(CH₃)₂ | —CH₂OCOCH(CH₃)₂ | —COCH₃ |
| (1-57) | —CH₃ | —CH₃ | —COCH(CH₃)₃ |
| (1-58) | —CH₃ | —CH₃ | —CO(CH₂)₁₀CH₃ |
| (1-59) | —CH₃ | —CH₃ | —COPh |
| (1-60) | —CH₃ | —CH₃ | —COPh |
| (1-61) | —CH₂CN | —CH₃ | —Cl |
| (1-62) | —CH₂CONH₂ | —CH₃ | —Cl |
| (1-63) | —CH₂CONHPh | —CH₃ | —Cl |
| (1-64) | —CH₂Ph | —CH₃ | —Cl |

The compound represented by Formula (1) is preferably produced using a compound represented by Formula (2) as an intermediate. A method for producing the compound represented by Formula (1) will be described later.

[Compound Represented by Formula (3)]

A compound represented by Formula (3) according to an embodiment of the present invention will be described.

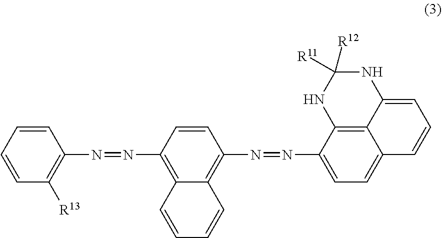

In Formula (3), R¹¹ and R¹² each independently represent an alkyl group having 1 to 12 carbon atoms, which may have a substituent, R¹³ represents a halogen atom, a nitro group, a cyano group, an alkoxycarbonyl group having 2 to 12 carbon atoms, or an acyl group having 2 to 12 carbon atoms, and R¹¹ and R¹² may be bonded to each other to form a ring.

In Formula (3), R¹¹ and R¹² each independently represent an alkyl group having 1 to 12 carbon atoms, which may have a substituent.

The alkyl group represented by R¹¹ and R¹² may be linear or branched.

The number of carbon atoms in the alkyl group represented by R¹¹ and R¹² is 1 to 12, preferably 1 to 8 and more preferably 1 to 5.

The alkyl group represented by R¹¹ and R¹² may have a substituent, and the substituent is not particularly limited. Examples thereof include a hydroxyl group, an alkylcarbonyloxy group (preferably, an alkylcarbonyloxy group having 2 to 8 carbon atoms), an alkylaminocarbonyloxy group (preferably, an alkylaminocarbonyloxy group having 2 to 8 carbon atoms), a cyano group, a carbamoyl group, an alkylcarbamoyl group (preferably, an alkylcarbamoyl group having 2 to 8 carbon atoms), an arylcarbamoyl group (preferably, an arylcarbamoyl group having 7 to 11 carbon atoms, and more preferably, a phenylcarbamoyl group), and an aryl group (preferably, an aryl group having 6 to 10 carbon atoms, and more preferably, a phenyl group).

It is preferable that the alkyl group represented by R¹¹ and R¹² has no substituent (that is, is an unsubstituted alkyl group).

R¹¹ and R¹² may be bonded to each other to form a ring.

In a case where R¹¹ and R¹² are bonded to each other to form a ring, R¹¹ and R¹² form an alkylene group. The number of carbon atoms in this alkylene group is preferably 2 to 12 and more preferably 2 to 8. This alkylene group may have a substituent, and the substituent is not particularly limited. Examples thereof include those groups described above as the substituent which may be included in the alkyl group.

From the viewpoint of the stability to heat, R¹¹ and R¹² preferably represent an unsubstituted alkyl group having 1 to 12 carbon atoms, or an alkyl group having 1 to 12 carbon atoms, which has, as a substituent, a hydroxyl group, an alkylcarbonyloxy group, or an alkylaminocarbonyloxy group. Furthermore, from the viewpoint of solubility and production cost, R¹¹ and R¹² more preferably represent an unsubstituted alkyl group having 1 to 12 carbon atoms, still more preferably represent an unsubstituted alkyl group having 1 to 8 carbon atoms, and particularly preferably represent an unsubstituted alkyl group having 1 to 5 carbon atoms.

Furthermore, from the viewpoint of solubility, it is particularly preferable that R¹¹ and R¹² are different from each other.

R¹³ in Formula (3) represents a halogen atom, a nitro group, a cyano group, an alkoxycarbonyl group having 2 to 12 carbon atoms, or an acyl group having 2 to 12 carbon atoms.

In a case where R¹³ represents a halogen atom, examples thereof include a fluorine atom, a chlorine atom, a bromine atom, and an iodine atom, and a fluorine atom or a chlorine atom is preferable and a chlorine atom is more preferable.

In a case where R¹³ represents an alkoxycarbonyl group having 2 to 12 carbon atoms, an alkoxycarbonyl group having 2 to 8 carbon atoms is preferable and an alkoxycarbonyl group having 2 to 5 carbon atoms is more preferable.

In a case where R¹³ represents an acyl group having 2 to 12 carbon atoms, an acyl group having 2 to 8 carbon atoms is preferable and an acyl group having 2 to 5 carbon atoms is more preferable. In addition, examples of the acyl group having 2 to 12 carbon atoms include an alkylcarbonyl group having 2 to 12 carbon atoms and an arylcarbonyl group having 6 to 12 carbon atoms (for example, a benzoyl group and the like), and an alkylcarbonyl group having 2 to 12 carbon atoms is preferable.

From the viewpoint of heat resistance, R¹³ is preferably a fluorine atom, a chlorine atom, a nitro group, a cyano group, an alkoxycarbonyl group having 2 to 12 carbon atoms, or an acyl group having 2 to 12 carbon atoms, more preferably a fluorine atom, a chlorine atom, a nitro group, a cyano group, or an acyl group having 2 to 12 carbon atoms, still more preferably a fluorine atom, a chlorine atom, a nitro group, a cyano group, or an alkylcarbonyl group having 2 to 12 carbon atoms, particularly preferably a chlorine atom, a cyano group, a nitro group, or an alkylcarbonyl group having 2 to 5 carbon atoms, and most preferably a chlorine atom, a nitro group, a cyano group, or an acetyl group.

Specific examples of the compound represented by Formula (3) are shown below, but the present invention is not limited thereto.

TABLE 5

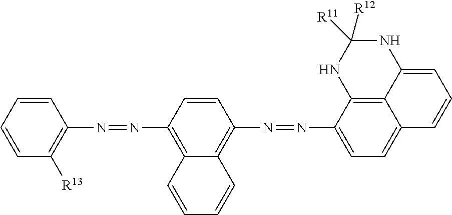

| Compound | R¹¹ | R¹² | R¹³ |
|---|---|---|---|
| (3-1) | —CH₃ | —CH₃ | —Cl |
| (3-2) | —CH₃ | —CH₃ | —F |
| (3-3) | —CH₃ | —CH₃ | —CO₂CH₃ |
| (3-4) | —CH₃ | —CH₃ | —CN |
| (3-5) | —CH₃ | —CH₃ | —NO₂ |
| (3-6) | —CH₃ | —CH₃ | —COCH₃ |
| (3-7) | —(CH₂)₂CH₃ | —CH₃ | —Cl |
| (3-8) | —(CH₂)₃CH₃ | —CH₃ | —Cl |
| (3-9) | —CH(CH₃)₂ | —CH₃ | —Cl |
| (3-10) | —(CH₂)₄CH₃ | —CH₃ | —Cl |

The compound represented by Formula (3) is preferably produced using a compound represented by Formula (2) as an intermediate. A method for producing the compound represented by Formula (3) will be described later.

[Compound Represented by Formula (2)]

A compound represented by Formula (2) according to an embodiment of the present invention will be described. The compound represented by Formula (2) can be used as a material (intermediate) in a case of synthesizing the compound represented by Formula (1).

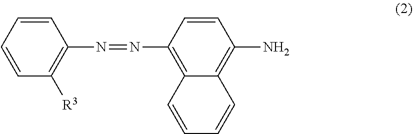

In Formula (2), R³ represents a halogen atom, a nitro group, a cyano group, an alkoxycarbonyl group having 2 to 12 carbon atoms, or an acyl group having 2 to 12 carbon atoms.

R³ in Formula (2) has the same meaning as R³ in Formula (1), and specific examples and preferred range thereof are the same.

Specific examples of the compound represented by Formula (2) are shown below, but the present invention is not limited thereto. Ph represents a phenyl group.

TABLE 6

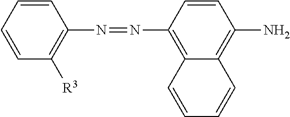

| Compound | R³ |
|---|---|
| (2-1) | —Cl |
| (2-2) | —F |
| (2-3) | —Br |
| (2-4) | —NO₂ |
| (2-5) | —CN |
| (2-6) | —CO₂CH₃ |
| (2-7) | —CO₂C₂H₅ |
| (2-8) | —CO₂CH(CH₃)₂ |
| (2-9) | —CO₂(CH₂)₃CH₃ |
| (2-10) | —OC₂(CH₂)₇CH₃ |
| (2-11) | —CO₂(CH₂)₁₀CH₃ |
| (2-12) | —COCH₃ |
| (2-13) | —COC(CH₃)₃ |
| (2-14) | —CO(CH₂)₁₀CH₃ |
| (2-15) | —COPh |

A method for producing the compound represented by Formula (2) is not particularly limited, and a preferred method thereof will be described in the preferred method for producing the compound represented by Formula (1) described below.

The method for producing the compound represented by Formula (1) is not particularly limited, but is preferably produced by a method including, for example,

a step (first step) of synthesizing an intermediate (CP) by condensing 1,8-diaminonaphthalene with a ketone compound (X),

a step (second step) of forming a diazonium salt from o-substituted aniline (Y) using a diazotizing agent, and then synthesizing the compound represented by Formula (2) by coupling the diazonium salt with 1-naphthylamine, and

a step (third step) of forming a diazonium salt from the compound represented by Formula (2) using a diazotizing agent, and then synthesizing the compound represented by Formula (1) (disazo compound) by coupling the diazonium salt with the intermediate (CP), in this order.

Specific scheme is shown below.

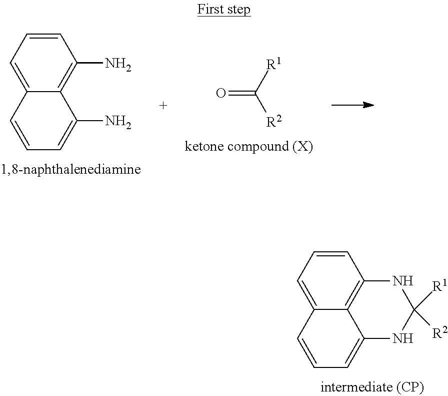

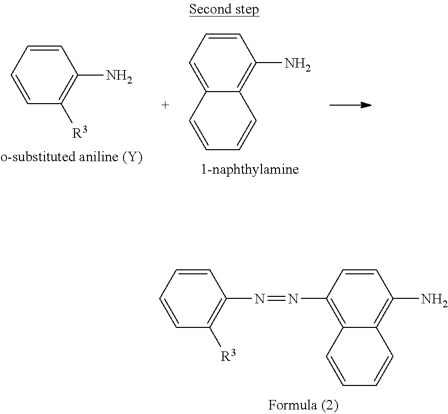

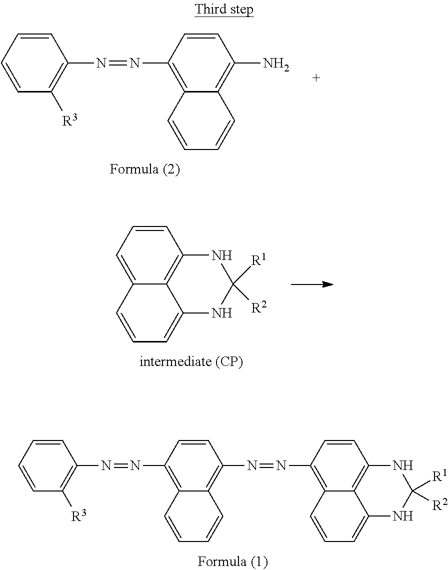

All the raw materials required for these syntheses are available as reagents. For example, 1,8-diaminonaphthalene is available as a reagent (catalog number: 043-00795) manufactured by FUJIFILM Wako Pure Chemical Corporation, 1-naphthylamine is available as a reagent (catalog number: N0052) manufactured by TOKYO CHEMICAL INDUSTRY CO., LTD., the ketone compound (X) is available as a reagent (catalog number: 037-02316, 066-02122, 143-01505, A10895, and the like) manufactured by FUJIFILM Wako Pure Chemical Corporation, and o-substituted aniline (Y) is available as a reagent (catalog number: 037-02316, 060-02125, 025-02492, and the like) manufactured by FUJIFILM Wako Pure Chemical Corporation.

In the first step, the reaction may be performed with a solvent or without a solvent. In a case of using a solvent, water, methanol, or ethanol can be preferably used. In addition, in the first step, a catalyst may be used, and concentrated sulfuric acid can be preferably used.

Examples of the diazotizing agent which can be used in the second step include sodium nitrite, nitrosylsulfuric acid, and nitrite esters (for example, isoamyl nitrite). Sodium nitrite is preferable because it is inexpensively available.

Examples of a solvent which can be used in the diazotization in the second step include water, acetic acid, propionic acid, hydrochloric acid, and sulfuric acid, and water is preferable in terms of inexpensive production.

In addition, in the diazotization in the second step, a strong acid is usually used. Examples of the strong acid include hydrochloric acid, sulfuric acid, phosphoric acid, and methanesulfonic acid, and hydrochloric acid or sulfuric acid can be preferably used. The amount of the strong acid used is usually 2.1 to 10 molar equivalents, preferably 2.1 to 4 molar equivalents with respect to the number of moles of o-substituted aniline.

In the diazotization in the second step, amidosulfate or urea may be used to inactivate the unreacted diazotizing agent.

Examples of a solvent used in the coupling reaction in the second step include water, methanol, acetone, tetrahydrofuran, acetonitrile, acetic acid, propionic acid, and a mixture thereof. The solvent depends on the reaction substrate, but acetone, methanol, or the like can be preferably used.

In the coupling reaction in the second step, a base may be used in combination to adjust pH. As the base, sodium hydroxide or sodium acetate can be used, but the reaction usually proceeds sufficiently without using the base in combination.

As the diazotizing agent, diazotizing solvent, strong acid required for the diazotization, inactivating agent for the unreacted diazotizing agent, and coupling solvent, all of which can be used in the third step, the same as those mentioned in the second step can be used.

The above-described compound represented by Formula (2) can be used as a material (intermediate) in a case of synthesizing the compound represented by Formula (3).

The method for producing the compound represented by Formula (3) is not particularly limited, and examples thereof include the same method as the method for producing the compound represented by Formula (1) described above.

The compound represented by Formula (1) and the compound represented by Formula (3) are coloring agents, and can be used for various applications. Examples of the applications of the compound represented by Formula (1) and the compound represented by Formula (3) include a coloring composition, an ink (for example, inkjet ink and the like), a toner, a coloring resin composition (for example, pellet and the like), and a composition for dyeing a fiber.

In particular, the compound represented by Formula (1) and the compound represented by Formula (3) can be used as an oil-soluble black dye, and since the compounds have more excellent stability to heat than Solvent Black 3, the compounds can be suitably used under conditions of higher temperature, in addition to the applications in which Solvent Black 3 has been used in the related art. For example, in a thermal method, the inkjet ink momentarily receives high-temperature heat. In addition, in the toner, since a coloring agent and a resin are melt-kneaded in a case of production, the coloring agent is required to have high heat resistance. Same as the toner, also in the coloring resin composition such as a coloring plastic, since a coloring agent and a resin are melt-kneaded, the coloring agent is required to have high heat resistance. Furthermore, also in the composition for dyeing a fiber, the dyeing conditions may be in a high temperature, and in this case, the coloring agent used is required to have high heat resistance.

The present invention relates to a coloring composition, an ink (for example, inkjet ink and the like), a toner, a coloring resin composition (for example, pellet and the like), and a composition for dyeing a fiber, which contain at least one of the compound represented by Formula (1) or the compound represented by Formula (3). However, except for containing, as a coloring agent, at least one of the compound represented by Formula (1) or the compound represented by Formula (3), techniques known in the respective fields of coloring compositions, inks, toners, coloring resin compositions, and compositions for dyeing a fiber (for example, other components, such as an additive, a solvent, and a resin, used in the preparation of each of the coloring composition, the ink, the toner, the coloring resin composition, and the composition for dyeing a fiber; preparation method; treatment method; and the like) can be applied. In particular, techniques known in the respective fields of coloring compositions, inks, toners, coloring resin compositions, and compositions for dyeing a fiber, which have been used in the related art for Solvent Black 3, can be preferably applied.

From the viewpoint of heat resistance and solubility in a solvent, it is preferable that the coloring composition according to an embodiment of the present invention contains the compound represented by Formula (1) and the compound represented by Formula (3).

In the coloring composition according to the embodiment of the present invention, as the content ratio of the compound represented by Formula (1) and the compound represented by Formula (3), (content of compound represented by Formula (1))/(content of compound represented by Formula (3)) is preferably 100 mass %/0 mass % to 40 mass %/60 mass %, more preferably 95 mass %/5 mass % to 50 mass %/50 mass %, and still more preferably 90 mass %/10 mass % to 60 mass %/40 mass %.

The ink, toner, coloring resin composition, and composition for dyeing a fiber according to an embodiment of the present invention preferably contain the compound represented by Formula (1) according to the embodiment of the present invention, the compound represented by Formula (3) according to the embodiment of the present invention, or the above-described coloring composition according to the embodiment of the present invention (preferably, a coloring resin composition containing the compound represented by Formula (1) and the compound represented by Formula (3)), respectively.

### EXAMPLES

Hereinafter, the present invention will be described more specifically with reference to examples, but the present invention is not limited to the following examples.

### Synthesis Example 1: Synthesis of Compound (1-3)

A compound (1-3) was synthesized according to the following scheme.

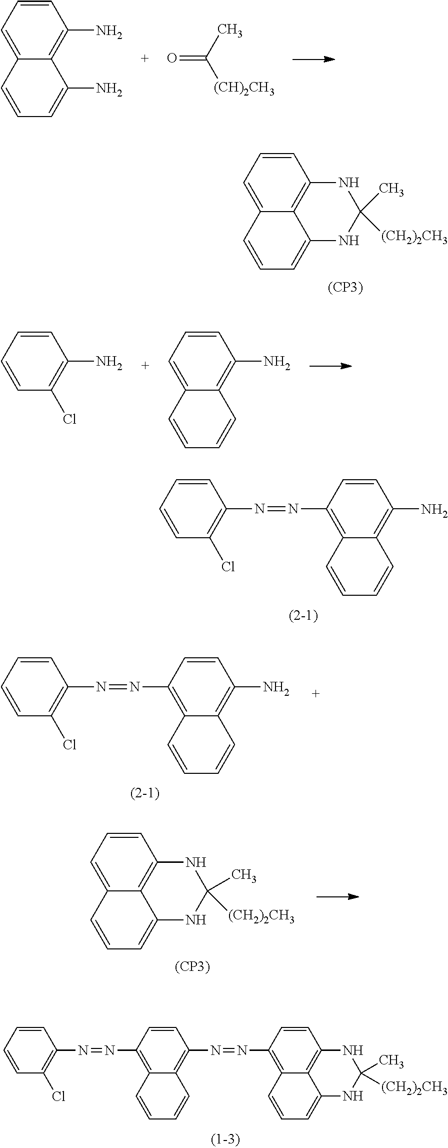

[Synthesis of Intermediate (CP3)]

158 g (1 mol) of 1,8-naphthalenediamine (manufactured by FUJIFILM Wako Pure Chemical Corporation) and 1400 mL of methanol were charged into a 3 L three-neck flask, and under ice-cooling, 57 g (0.6 mol) of concentrated sulfuric acid (manufactured by FUJIFILM Wako Pure Chemical Corporation, special grade reagent) was slowly added dropwise thereto while maintaining an internal temperature at 40° C. or lower. 100 g (1.16 mol) of 2-pentanone (manufactured by FUJIFILM Wako Pure Chemical Corporation, first grade reagent) corresponding to the ketone compound (X) was injected into this suspension, and the reaction was performed at an internal temperature of 55° C. for 1 hour. The reaction solution was cooled to room temperature (25° C.), and under water-cooling, 1500 mL of a 2 mol/L sodium hydroxide aqueous solution was slowly added dropwise thereto. The mixture was stirred at room temperature for 15 minutes, subjected to vacuum filtration, and washed with 1000 mL of water/methanol=1/1 (v/v), 1000 mL of water, and 1000 mL of water/methanol=1/1 (v/v). Thereafter, the obtained powder was dried with a blast dryer at 50° C. for 24 hours to obtain an intermediate (CP3) as a light brown powder (quantity: 210 g, yield: 93%).

[Synthesis of Compound (2-1)]

71.4 g (0.56 mol) of o-chloroaniline (manufactured by FUJIFILM Wako Pure Chemical Corporation, special grade reagent) corresponding to o-substituted aniline (Y) and 560 mL of water were charged into a 1 L three-neck flask, and under ice-cooling, 140 mL (1.68 mol) of concentrated hydrochloric acid (manufactured by FUJIFILM Wako Pure Chemical Corporation, special grade reagent) was slowly added dropwise thereto while maintaining an internal temperature at 10° C. or lower. An aqueous solution of 38.64 g of sodium nitrite (manufactured FUJIFILM Wako Pure Chemical Corporation, special grade reagent) dissolved in 69.6 g of water was slowly added dropwise to this solution while maintaining an internal temperature at 0° C. to 5° C., and the reaction was performed at an internal temperature of 0° C. to 5° C. for 15 minutes. 5.44 g of amidosulfate (manufactured by FUJIFILM Wako Pure Chemical Corporation, first grade reagent) was added thereto, and the reaction was performed at an internal temperature of 0° C. to 5° C. for 15 minutes to prepare a diazonium salt solution.

Separately, 76.2 g (0.53 mol) of 1-naphthylamine (manufactured by Mahatme Dye Chem Pvt Ltd.) and 1,904 mL of acetone were charged into a 3 L three-neck flask, and an internal temperature thereof was cooled to 15° C. The diazonium salt solution prepared above was carefully added dropwise to this solution while maintaining an internal temperature at 15° C. to 20° C., and the reaction was performed at an internal temperature of 15° C. to 20° C. for 30 minutes. Crystals precipitated from the reaction solution were collected by vacuum filtration, and washed with 1000 mL of acetone/water=1/1 (v/v). 1500 mL of acetone/ethyl acetate=1/1 (v/v) was added to the wet cake of the crystals, and the solution was heated to 45° C. to 50° C. and stirred for 15 minutes, subjected to hot filtration, washed with 500 mL of acetone/ethyl acetate=1/1 (v/v), and dried with a blast dryer at 40° C. for 6 hours to obtain hydrochloride of a compound (2-1) as dark green crystals (quantity: 142 g, yield: 85%).

[Synthesis of Compound (1-3)]

29.8 g (0.094 mol) of hydrochloride of the compound (2-1), 172 mL of water, 120 mL of acetic acid (manufactured by FUJIFILM Wako Pure Chemical Corporation, special grade reagent), and 172 mL of propionic acid (manufactured by FUJIFILM Wako Pure Chemical Corporation, special grade reagent) were charged into a 1 L three-neck flask, and an internal temperature thereof was cooled to 5° C. 22.4 mL (0.269 mol) of concentrated hydrochloric acid (manufactured by FUJIFILM Wako Pure Chemical Corporation, special grade reagent) was carefully added dropwise thereto under an internal temperature of 10° C., and then an aqueous solution of 6.48 g (0.094 mol) of sodium nitrite (manufactured by FUJIFILM Wako Pure Chemical Corporation, special grade reagent) dissolved in 25.6 mL of water was slowly added dropwise thereto while maintaining an internal temperature at 0° C. to 5° C., and the reaction was performed at an internal temperature of 0° C. to 5° C. for 1 hour [diazonium salt solution].

Separately, 21.28 g (0.094 mol) of the intermediate (CP3), 0.87 g (0.009 mol) of amidosulfate (manufactured by FUJIFILM Wako Pure Chemical Corporation, first grade reagent), 128 mL of tetrahydrofuran (manufactured by FUJIFILM Wako Pure Chemical Corporation, special grade reagent), and 128 mL of water were charged in a 2 L three-neck flask, and an internal temperature thereof was cooled to 5° C. The diazonium salt solution prepared above was slowly added dropwise thereto while maintaining an internal temperature at 5° C. to 10° C., and the reaction was performed at an internal temperature of 0° C. to 10° C. for 30 minutes and then at an internal temperature of 15° C. to 20° C. for 30 minutes. 576 mL of acetone was added dropwise thereto, and precipitated crystals solution were collected by vacuum filtration and washed with acetone/water=1/1 (v/v). 3000 mL of ethyl acetate and 1200 mL of water were added to the obtained wet cake, and the solution was stirred and neutralized to pH 8 with a sodium hydrogen carbonate aqueous solution. Thereafter, insoluble matters were removed by celite filtration, only the ethyl acetate layer was concentrated using a rotary evaporator, and the obtained residue was recrystallized with methanol, thereby obtaining a compound (1-3) as dark green glossy crystals (quantity: 30.6 g, yield: 64%). Mass spectrometry (MS) (m/z): 520 ([M+1]⁺, 100%). The melting point of the compound (1-3) was 105° C.

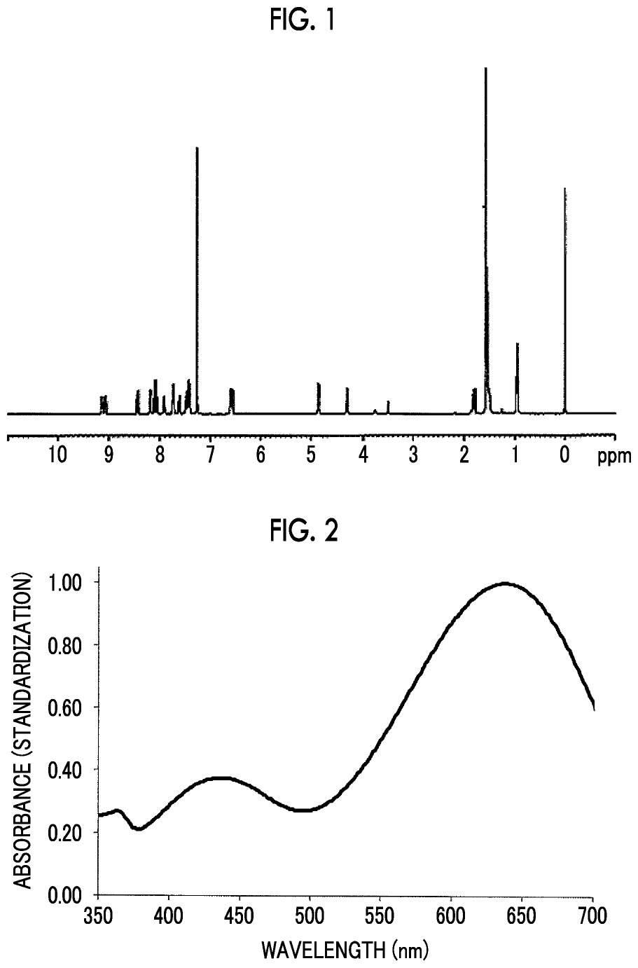

FIG. 1 shows a ¹H-NMR spectrum (in deuterated chloroform) of the compound (1-3).

Compounds (1-1), (1-2), (1-4), (1-5), (1-8), (1-9), (1-17), (1-20), (1-21), (1- 27), (1-31), (1-34), (1-36), (1-38), (1-40), (1-48), (1-50), (1-59), (1-61), (1-62), and (1-64) were synthesized in the same manner described above, except that at least one of 2-pentanone corresponding to the ketone compound (X) or o-chloroaniline corresponding to o-substituted aniline (Y) was modified.

In the syntheses of the compounds (1-1), (1-2), (1-4), (1-5), (1-8), (1-9), (1-17), (1-20), (1-21), (1-27), (1-61), (1-62), and (1-64), the compound (2-1) was used as an intermediate.

In the synthesis of the compound (1-31), a compound (2-2) was used as an intermediate.

In the synthesis of the compound (1-34), a compound (2-3) was used as an intermediate.

In the synthesis of the compound (1-36), a compound (2-4) was used as an intermediate.

In the synthesis of the compound (1-38), a compound (2-5) was used as an intermediate.

In the synthesis of the compound (1-40), a compound (2-6) was used as an intermediate.

In the synthesis of the compounds (1-48) and (1-50), a compound (2-12) was used as an intermediate.

In the synthesis of the compound (1-59), a compound (2-15) was used as an intermediate.

### Synthesis Example 2: Synthesis of Compound (3-7)

A compound (3-7) was synthesized according to the following scheme.

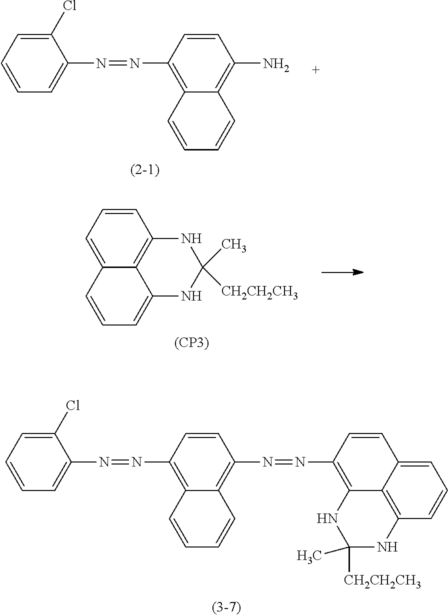

29.8 g (0.094 mol) of hydrochloride of the above-described compound (2-1), 172 mL of water, 120 mL of acetic acid (manufactured by FUJIFILM Wako Pure Chemical Corporation, special grade reagent), and 172 mL of propionic acid (manufactured by FUJIFILM Wako Pure Chemical Corporation, special grade reagent) were charged into a 1 L three-neck flask, and an internal temperature thereof was cooled to 5° C. 22.4 mL (0.269 mol) of concentrated hydrochloric acid (manufactured by FUJIFILM Wako Pure Chemical Corporation, special grade reagent) was carefully added dropwise thereto under an internal temperature of 10° C., and then an aqueous solution of 6.48 g (0.094 mol) of sodium nitrite (manufactured by FUJIFILM Wako Pure Chemical Corporation, special grade reagent) dissolved in 25.6 mL of water was slowly added dropwise thereto while maintaining an internal temperature at 0° C. to 5° C., and the reaction was performed at an internal temperature of 0° C. to 5° C. for 1 hour [diazonium salt solution].

Separately, 21.28 g (0.094 mol) of the above-described intermediate (CP3), 0.87 g (0.009 mol) of amidosulfate (manufactured by FUJIFILM Wako Pure Chemical Corporation, first grade reagent), 128 mL of tetrahydrofuran (manufactured by FUJIFILM Wako Pure Chemical Corporation, special grade reagent), and 128 mL of water were charged in a 2 L three-neck flask, and an internal temperature thereof was cooled to 5° C. The diazonium salt solution prepared above was slowly added dropwise thereto while maintaining an internal temperature at 5° C. to 10° C., and the reaction was performed at an internal temperature of 0° C. to 10° C. for 30 minutes and then at an internal temperature of 15° C. to 20° C. for 30 minutes. 576 mL of acetone was added dropwise thereto, and precipitated crystals solution were collected by vacuum filtration and washed with acetone/water=1/1 (v/v). 3000 mL of ethyl acetate and 1200 mL of water were added to the obtained wet cake, and the solution was stirred and neutralized to pH 8 with a sodium hydrogen carbonate aqueous solution. Thereafter, insoluble matters were removed by celite filtration, and only the ethyl acetate layer was concentrated using a rotary evaporator. The obtained residue was subjected to silica gel column, thereby obtaining a compound (3-7) (quantity: 5.4 g, yield: 11%).

Mass spectrometry (MS) (m/z): 520 ([M+1]⁺, 100%). The melting point of the compound (3-7) was 152° C. NMR (DMSO-d₆): 0.88 (t, 3H), 1.43 (m, 5H), 1.72 (m, 2H), 6.60 (d, 1H), 6.94 (d, 1H), 6.96 (d, 1H), 7.20 (s, 1H), 7.36 (t, 1H), 7.57 to 7.61 (t, 2H), 7.77 (d, 1H), 7.79 (d, 1H), 7.84 (m, 2H), 7.97 (d, 1H), 8.04 (d, 1H), 8.17 (d, 1H), 8.82 (d, 1H), 9.07 (d, 1H), 9.90 (brs, 1H)

Compounds (3-1) to (3-6), and (3-8) to (3-10) were synthesized in the same manner described above, except that at least one of 2-pentanone corresponding to the ketone compound (X) or o-chloroaniline corresponding to o-substituted aniline (Y) was modified.

In the syntheses of the compounds (3-1), (3-8), (3-9), and (3-10), the compound (2-1) was used as an intermediate.

In the synthesis of the compound (3-2), the compound (2-2) was used as an intermediate.

In the synthesis of the compound (3-5), the compound (2-4) was used as an intermediate.

In the synthesis of the compound (3-4), the compound (2-5) was used as an intermediate.

In the synthesis of the compound (3-3), the compound (2-6) was used as an intermediate.

In the synthesis of the compound (3-6), the compound (2-12) was used as an intermediate.

<Evaluation of Maximum Absorption Wavelength>

Table 7 shows the absorption maximum wavelength and molar light absorption coefficient of an absorption spectrum of each compound in a tetrahydrofuran solution (concentration: 1×10⁻⁶ mol/L, optical path length: 10 mm).

In addition, FIG. 2 shows an absorption spectrum of the compound (1-36) in a dilute solution of tetrahydrofuran.

TABLE 7

| | | Molar light | |
|---|---|---|---|
| | Absorption | absorption | |
| | maximum | coefficient | |
| | wavelength | (L · mol⁻¹ · | |
| Compound | (nm) | cm⁻¹) | Note |
| (1-1) | 624 | 34,500 | Example 1A |
| (1-2) | 627 | 34,000 | Example 2A |
| (1-3) | 629 | 34,400 | Example 3A |
| (1-4) | 631 | 33,000 | Example 4A |
| (1-5) | 629 | 35,100 | Example 5A |
| (1-8) | 631 | 35,200 | Example 6A |
| (1-9) | 629 | 35,900 | Example 7A |
| (1-17) | 622 | 33,100 | Example 8A |
| (1-20) | 623 | 33,800 | Example 9A |
| (1-31) | 619 | 35,000 | Example 10A |
| (1-36) | 638 | 30,100 | Example 11A |
| (1-38) | 648 | 28,900 | Example 12A |
| (1-40) | 599 | 26,600 | Example 13A |
| (1-48) | 624 | 34,100 | Example 14A |
| (1-50) | 629 | 34,900 | Example 15A |
| (1-21) | 623 | 33,900 | Example 16A |
| (1-61) | 604 | 34,100 | Example 17A |
| (1-62) | 607 | 34,200 | Example 18A |
| (1-64) | 631 | 36,800 | Example 19A |
| (1-34) | 621 | 32,800 | Example 20A |
| (1-27) | 629 | 34,800 | Example 21A |
| (1-59) | 639 | 35,700 | Example 22A |
| OIL BLACK HBB | 605 | 29,400 | Comparative |
| (trade name, | | | Example lA |
| manufactured by Orient | | | |
| Chemical Industries | | | |
| Co., Ltd.) | | | |

<Evaluation of Heat Stability (Heat Resistance)>

Heat stability of each compound was evaluated by the following procedure. 10 mg of the powder of each compound was dissolved in 500 mL of tetrahydrofuran, and the absorption spectrum was measured to obtain a reference absorbance (A₀). On the other hand, 10 mg of the powder of each compound was weighed in a 4 cm square aluminum cup, placed in an oven, and heated at 180° C. for 5 minutes. The entire amount of the powder after heating was dissolved in 500 mL of tetrahydrofuran, and the absorption spectrum was measured to obtain an absorbance (A) after the heating test. The residual rate of each compound was calculated by the following expression to evaluate heat stability. The results are shown in Table 8.

Residual rate of compound (%)=A/A₀×100

TABLE 8

| | Residual | |
|---|---|---|
| | rate of | |
| | compound | |
| Compound | (%) | Note |
| (1-1) | 85 | Example 1B |
| (1-2) | 84 | Example 2B |
| (1-3) | 82 | Example 3B |
| (1-4) | 84 | Example 4B |
| (1-5) | 81 | Example 5B |
| (1-8) | 81 | Example 6B |
| (1-9) | 84 | Example 7B |
| (1-17) | 89 | Example 8B |
| (1-20) | 84 | Example 9B |
| (1-31) | 90 | Example 10B |
| (1-36) | 98 | Example 11B |
| (1-38) | 92 | Example 12B |
| (1-40) | 80 | Example 13B |
| (1-48) | 99 | Example 14B |
| (1-50) | 98 | Example 15B |
| (1-21) | 84 | Example 16B |
| (1-61) | 77 | Example 17B |
| (1-62) | 74 | Example 18B |
| (1-64) | 73 | Example 19B |
| (1-34) | 74 | Example 20B |
| (1-27) | 81 | Example 21B |
| (1-59) | 82 | Example 22B |
| OIL BLACK HBB | 51 | Comparative |
| (trade name, manufactured | | Example 1B |
| by Orient Chemical Industries | | |
| Co., Ltd.) | | |
| Comparative compound A | 63 | Comparative |
| | | Example 2B |
| Comparative compound B | 64 | Comparative |
| | | Example 3B |

Solvent Black 3 (the following compound) as a main component of OIL BLACK HBB (trade name, manufactured by Orient Chemical Industries Co., Ltd.)

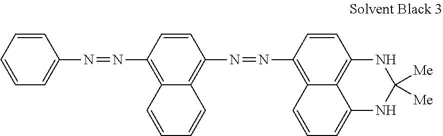 [SMILES: CC1(C)Nc2cccc3c(N=Nc4ccc(N=Nc5ccccc5)c5ccccc45)ccc(c23)N1]

The comparative compound A is the following compound.

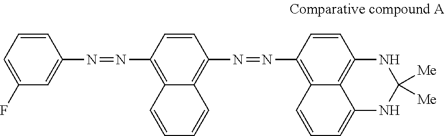 [SMILES: CC1(C)Nc2cccc3c(N=Nc4ccc(N=Nc5cccc(F)c5)c5ccccc45)ccc(c23)N1]

The comparative compound B is the following compound.

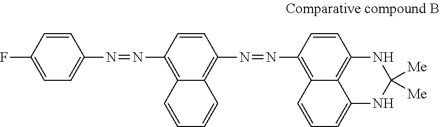 [SMILES: CC1(C)Nc2cccc3c(N=Nc4ccc(N=Nc5ccc(F)cc5)c5ccccc45)ccc(c23)N1]

Me represents a methyl group.

As is clear from the results in Table 8, it is found that the compound represented by Formula (1) according to the embodiment of the present invention has excellent heat stability as compared with Solvent Black 3 (OIL BLACK HBB). In addition, in comparison with the compound (1-31) and the comparative compound A and comparative compound B, it is found that the compound according to the embodiment of the present invention, which has a substituent at a specific position (ortho position to the azo group, R³ in Formula (1)), has excellent heat stability.

### Example 23

<Production of Inkjet Ink>

5.63 g of the compound according to the embodiment of the present invention (compound (1-9)), 7.04 g of sodium dioctyl sulfosuccinate, 4.22 g of an organic solvent (S-1) described later, and 5.63 g of an organic solvent (S-2) described later were dissolved in 50 ml of ethyl acetate at 70° C. 500 ml of deionized water was added to this solution while stirring with a magnetic stirrer, so as to prepare an oil-in-water type coarse dispersion.

Next, the coarse dispersion was passed through a microfluidizer (manufactured by MICROFLUIDEX Inc.) at a pressure of 60 MPa five times to form fine particles, and further, the resulting emulsion was desolvated by a rotary evaporator until the odor of ethyl acetate disappeared. An inkjet ink was produced by adding, to the fine emulsion of the compound (1-9) obtained above, 140 g of diethylene glycol, 50 g of glycerin, 7 g of SURFYNOL 465 (trade name, manufactured by Air Products & Chemicals Inc.), and 900 ml of deionized water.

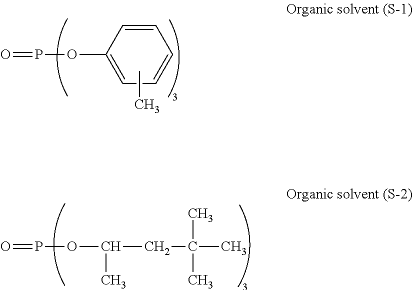

The obtained inkjet ink was packed in a cartridge of an inkjet printer (Material printer DMP-2850, trade name, manufactured by FUJIFILM Corporation), and on the same machine, images were recorded on an inkjet paper photo finishing Pro (trade name, manufactured by FUJIFILM Corporation). It was found that, since the obtained inkjet ink had excellent ink ejection stability and the obtained image had excellent spectral characteristics as black color, the obtained inkjet ink exhibited excellent properties as an inkjet ink.

### Example 24

<Production of Toner>

After mixing and pulverizing 3 g of the compound according to the embodiment of the present invention (compound (1-36)) and 100 g of a resin for toner [styrene-acrylic acid ester copolymer; HIMER TB-1000F (trade name, manufactured by Sanyo Chemical Industries, Ltd.)] with a ball mill, the resultant was heated at 150° C. to be melted and mixed, and the results were cooled, roughly pulverized using a hammer mill, and then finely pulverized using a fine pulverizer with an air-jet system. Furthermore, particles which have a particle diameter of 1 to 20 μm were classified and selected to produce a toner.

900 g of carrier iron powder (EFV250/400, trade name, manufactured by Powdertech Co., Ltd.) were uniformly mixed with 10 g of the toner to prepare a developer. Using this developer, copying was performed with a dry type plain paper electrophotographic copier [NP-5000, trade name, manufactured by Canon Inc.]. Pyrolysis in melting and mixing in the toner production was reduced. In addition, it was found that, since the obtained copy printed matter had excellent black spectral characteristics, the obtained toner exhibited excellent properties as a toner.

### Example 25

<Production of Coloring Resin Composition>

Using a henschel mixer, a blend of 100 g of polybutylene terephthalate (manufactured by Wintech Polymer Ltd., trade name, DURANEX 2002, melting point: 225° C.) and 1 g of the compound according to the embodiment of the present invention (compound (1-48)) was supplied to a biaxial extruder (equipment: TEX28V manufactured by Japan Steel Works, Ltd., screw speed: 200 rotations per minute (rpm)), and kneading was performed at a cylinder temperature of 190° C. to obtain a coloring resin pellet (coloring resin composition). The torque of the extruder was stable and extrusion could be continued, and the discharged strands could be stably conveyed to the pelletizer. No contamination due to pyrolysis was observed.

### Comparative Example 4

A coloring resin pellet was obtained in the same manner as in Example 25, except that the compound (1-48) of Example 25 was changed to OIL BLACK HBB (manufactured by Orient Chemical Industries Co., Ltd., trade name). Contamination of the equipment, in which brown components considered due to pyrolysis were volatilized, was confirmed.

### Example 26

<Production of Composition for Dyeing Fiber>

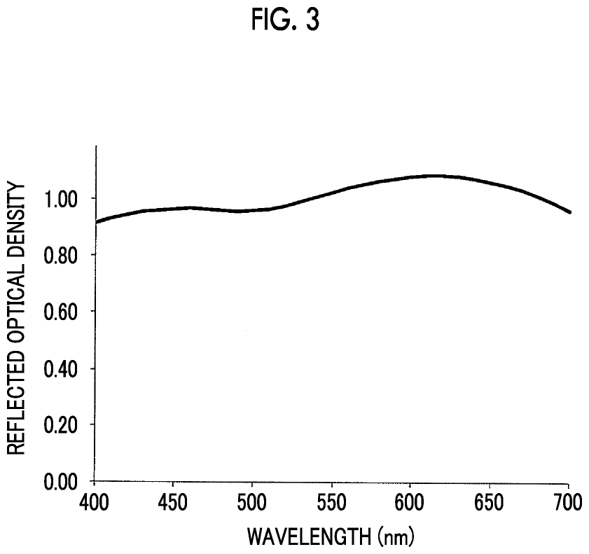

3 g of the compound according to the embodiment of the present invention (compound (1-1)), 5 g of DEMOL N (trade name, manufactured by Kao Corporation) as a dispersion aid, and 500 mL of an acetic acid-sodium acetate buffered aqueous solution (pH: 4.5) were well stirred to produce a composition for dyeing a fiber. A dye bath in which this composition for dyeing a fiber was heated to 60° C. was prepared. A polyester cloth (polyester broad, manufactured by Shikisensha Co., Ltd.) was dipped in the dye bath at a ratio of mass of composition for dyeing a fiber:mass of polyester cloth=30:1 to start dyeing, the dye bath was heated to 90° C. over 30 minutes and then pressurized and heated to 130° C. over 30 minutes, and the polyester cloth was dyed at the same temperature for 60 minutes. In order to remove undyed dye adhering to the obtained dyed cloth, the obtained dyed cloth was cleaned with a reducing cleaning solution, in which 2 g of sodium hydroxide, 1 g of SUNMORL RC-700 (trade name, manufactured by NICCA CHEMICAL CO., LTD.), 2 g of hydrosulfite soda, and 1 L of water were mixed, at 80° C. for 10 minutes at a bath ratio of 30:1, and further cleaned with water and dried, thereby obtaining a deep bluish-black dyed cloth. The reflection spectrum of the obtained cloth is shown in FIG. 3.

<Evaluation 2 of Maximum Absorption Wavelength>

Table 9 shows the absorption maximum wavelength and molar light absorption coefficient of an absorption spectrum of each compound in a tetrahydrofuran solution (concentration: 1×10⁻⁶ mol/L, optical path length: 10 mm).

TABLE 9

| | | Molar light | |
|---|---|---|---|
| | Absorption | absorption | |
| | maximum | coefficient | |
| | wavelength | (L · mol⁻¹ · | |
| Compound | (nm) | cm⁻¹) | Note |
| (3-1) | 612 | 36300 | Example 101A |
| (3-2) | 608 | 36000 | Example 102A |
| (3-3) | 586 | 29200 | Example 103A |
| (3-4) | 638 | 30500 | Example 104A |
| (3-5) | 627 | 32100 | Example 105A |
| (3-6) | 615 | 36100 | Example 106A |
| (3-7) | 617 | 36200 | Example 107A |
| (3-8) | 616 | 35800 | Example 108A |
| (3-9) | 614 | 35500 | Example 109A |
| (3-10) | 615 | 34800 | Example 110A |
| Comparative | 607 | 32000 | Comparative |
| compound C | | | Example 101A |
| Comparative | 599 | 34200 | Comparative |
| compound D | | | Example 102A |

The comparative compound C is the following compound.

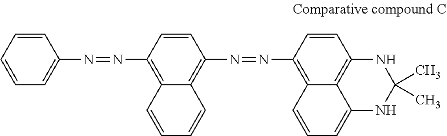 [SMILES: CC1(C)Nc2cccc3c(N=Nc4ccc(N=Nc5ccccc5)c5ccccc45)ccc(c23)N1]

The comparative compound D is the following compound.

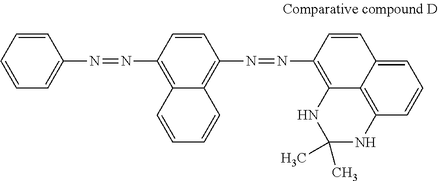 [SMILES: CC1(C)Nc2cccc3ccc(N=Nc4ccc(N=Nc5ccccc5)c5ccccc45)c(c23)N1]

<Evaluation 2 of Heat Stability (Heat Resistance)>

Heat stability of each compound was evaluated by the following procedure. 10 mg of the powder of each compound was dissolved in 500 mL of tetrahydrofuran, and the absorption spectrum was measured to obtain a reference absorbance (A₀). On the other hand, 10 mg of the powder of each compound was weighed in a 4 cm square aluminum cup, placed in an oven, and heated at 200° C. for 5 minutes. The entire amount of the powder after heating was dissolved in 500 mL of tetrahydrofuran, and the absorption spectrum was measured to obtain an absorbance (A2) after the heating test. The residual rate of each compound was calculated by the following expression to evaluate heat stability. The results are shown in Table 10.

Residual rate of compound (%)=A2/A₀×100

TABLE 10

| | Residual rate of | |
|---|---|---|
| Compound | compound (%) | Note |
| (3-1) | 83 | Example 101B |
| (3-2) | 85 | Example 102B |
| (3-3) | 86 | Example 103B |
| (3-4) | 88 | Example 104B |
| (3-5) | 95 | Example 105B |
| (3-6) | 96 | Example 106B |
| (3-7) | 85 | Example 107B |
| (3-8) | 87 | Example 108B |
| (3-9) | 85 | Example 109B |
| (3-10) | 88 | Example 110B |
| Comparative | 59 | Comparative Example |
| compound C | | 101B |
| Comparative | 65 | Comparative Example |
| compound D | | 102B |

As is clear from the results in Table 10, it is found that the compound represented by Formula (3) according to the embodiment of the present invention has excellent heat stability as compared with the comparative compound C corresponding to Solvent Black 3 or the comparative compound D which is a regioisomer of Solvent Black 3.

<Preparation of Coloring Composition Including Compound Represented by Formula (3)>

0.10 g of the compound (3-1) and 0.90 g of the compound (1-1) were added to 9 g of ethyl acetate, and the mixture was stirred at 40° C. for 1 hour to completely dissolve the mixture, thereby obtaining a coloring composition (1).

Coloring compositions (2) to (11) were obtained in the same manner as in the coloring composition (1), except that the compound represented by Formula (1), the compound represented by Formula (3), and the blending amount thereof were changed as shown in Table 11 below.

<Evaluation 3 of Heat Stability (Heat Resistance)>

Heat stability of each composition was evaluated by the following procedure. 0.10 g of each coloring composition was applied to a 2.5 cm square glass substrate, and dried at 40° C. for 1 hour. The obtained glass substrate was immersed in 500 mL of tetrahydrofuran to dissolve the coloring composition, and the reference absorbance (A₀₁) was obtained. On the other hand, a glass substrate produced as described above was placed in an oven, heated at 200° C. for 5 minutes, and immersed in 500 mL of tetrahydrofuran to dissolve the coloring composition, and the absorption spectrum was measured to obtain an absorbance (A3) after the heating test. The residual rate of each coloring composition was calculated by the following expression to evaluate heat stability. The results are shown in Table 11.

Residual rate of compound (%)=A3/A₀₁×100

TABLE 11

| | Compound represented | | Compound represented | | Residual rate | |
|---|---|---|---|---|---|---|
| | by Formula (1) | | by Formula (3) | | of compound | |
| | Type | Content (g) | Type | Content (g) | (%) | Note |
| Coloring | (1-1) | 0.90 | (3-1) | 0.10 | 81 | Example 111B |
| composition (1) | | | | | | |
| Coloring | (1-31) | 0.90 | (3-2) | 0.10 | 82 | Example 112B |
| composition (2) | | | | | | |
| Coloring | (1-40) | 0.90 | (3-3) | 0.10 | 85 | Example 113B |
| composition (3) | | | | | | |
| Coloring | (1-38) | 0.90 | (3-4) | 0.10 | 86 | Example 114B |
| composition (4) | | | | | | |
| Coloring | (1-36) | 0.90 | (3-5) | 0.10 | 92 | Example 115B |
| composition (5) | | | | | | |
| Coloring | (1-48) | 0.90 | (3-6) | 0.10 | 94 | Example 116B |
| composition (6) | | | | | | |
| Coloring | (1-3) | 0.90 | (3-7) | 0.10 | 80 | Example 117B |
| composition (7) | | | | | | |
| Coloring | (1-3) | 0.70 | (3-7) | 0.30 | 81 | Example 118B |
| composition (8) | | | | | | |
| Coloring | (1-3) | 0.50 | (3-7) | 0.50 | 82 | Example 119B |
| composition (9) | | | | | | |
| Coloring | - | - | (3-7) | 1.00 | 84 | Example 120B |
| composition (10) | | | | | | |

| | | | |
|---|---|---|---|
| Coloring | OIL BLACK HBB (trade name, manufactured by | 47 | Comparative |
| composition (11) | Orient Chemical Industries Co., Ltd.) | | Example 103B |

From the above, it is found that the coloring composition including the compound represented by Formula (3), and the coloring composition including the compound represented by Formula (1) and the compound represented by Formula (3) have higher heat stability than OIL BLACK HBB containing Solvent Black 3.

<Solubility Test of Compound>

Solubility of the coloring compositions (7) to (10) was measured as follows. 5.0 g of a tetrahydrofuran solution of each coloring composition was prepared in vials so as to be 10 mass %, 15 mass %, and 20 mass %. The vial was closed and shaken in a hot water bath at 40° C. for 30 minutes. The obtained coloring solution was filtered using a 1 μm membrane filter. The one which could be filtered was defined as A, the one which could not be filtered was defined as B.

TABLE 12

| | 10 | 15 | 20 | |
|---|---|---|---|---|
| | mass % | mass % | mass % | Note |
| Coloring composition (7) | A | A | A | Example 117C |
| Coloring composition (8) | A | A | A | Example 118C |
| Coloring composition (9) | A | A | A | Example 119C |
| Coloring composition (10) | A | B | B | Example 120C |

From the results shown in Table 12, it is found that a case (coloring compositions (7) to (9)) where the compound represented by Formula (1) and the compound represented by Formula (3) are used in combination has excellent solubility even in a case where the concentration of the coloring agent is high.

According to the present invention, it is possible to provide a compound which can be used as an oil-soluble black dye and has more excellent stability to heat than Solvent Black 3; a coloring composition, an ink, a toner, a coloring resin composition, and a composition for dyeing a fiber, which contain the compound; and an intermediate useful for a production of the compound.

The present invention has been described with reference to detailed and specific embodiments, but various changes or modifications can be made without departing from the spirit and the scope of the present invention and this is apparent to those skilled in the art.

What is claimed is:

1. A compound represented by the following Formula (1), 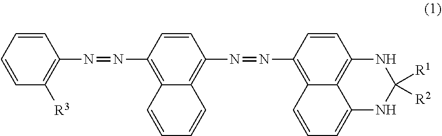
wherein, in the Formula (1), R¹ and R² each independently represent an alkyl group having 1 to 12 carbon atoms, and the alkyl group having 1 to 12 carbon atoms may have a substituent; R³ represents a halogen atom, a nitro group, a cyano group, an alkoxycarbonyl group having 2 to 12 carbon atoms, or an acyl group having 2 to 12 carbon atoms; and R¹ and R² may be bonded to each other to form a ring.

2. The compound according to claim 1,
wherein R¹ and R² each independently represent the alkyl group having 1 to 12 carbon atoms, the alkyl group being unsubstituted, or substituted with a hydroxyl group, an alkylcarbonyloxy group, or an alkylaminocarbonyloxy group.

3. The compound according to claim 1,
wherein R¹ and R² are different from each other.

4. The compound according to claim 2,
wherein R¹ and R² are different from each other.

5. The compound according to claim 1,
wherein R³ represents a fluorine atom, a chlorine atom, a nitro group, a cyano group, or an acyl group having 2 to 12 carbon atoms.

6. The compound according to claim 2,
wherein R³ represents a fluorine atom, a chlorine atom, a nitro group, a cyano group, or an acyl group having 2 to 12 carbon atoms.

7. The compound according to claim 3,
wherein R³ represents a fluorine atom, a chlorine atom, a nitro group, a cyano group, or an acyl group having 2 to 12 carbon atoms.

8. A compound represented by the following Formula (3), 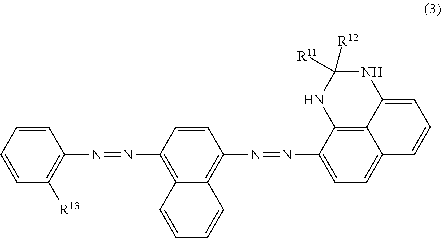
wherein, in the Formula (3), R¹¹ and R¹² each independently represent an alkyl group having 1 to 12 carbon atoms, and the alkyl group having 1 to 12 carbon atoms may have a substituent; R¹³ represents a halogen atom, a nitro group, a cyano group, an alkoxycarbonyl group having 2 to 12 carbon atoms, or an acyl group having 2 to 12 carbon atoms; and R¹¹ and R¹² may be bonded to each other to form a ring.

9. The compound according to claim 8,
wherein R¹¹ and R¹² each independently represent the alkyl group having 1 to 12 carbon atoms, the alkyl group being unsubstituted, or substituted with a hydroxyl group, an alkylcarbonyloxy group, or an alkylaminocarbonyloxy group.

10. The compound according to claim 8,
wherein R¹¹ and R¹² are different from each other.

11. The compound according to claim 9,
wherein R¹¹ and R¹² are different from each other.

12. The compound according to claim 8,
wherein R¹³ represents a fluorine atom, a chlorine atom, a nitro group, a cyano group, or an acyl group having 2 to 12 carbon atoms.

13. The compound according to claim 9,
wherein R¹³ represents a fluorine atom, a chlorine atom, a nitro group, a cyano group, or an acyl group having 2 to 12 carbon atoms.

14. A coloring composition comprising:
the compound according to claim 1.

15. The coloring composition according to claim 14, further comprising:
a compound represented by the following Formula (3), 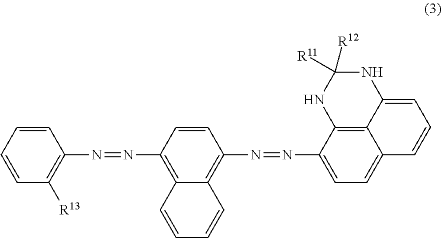
wherein, in the Formula (3), R¹¹ and R¹² each independently represent an alkyl group having 1 to 12 carbon atoms, and the alkyl group having 1 to 12 carbon atoms may have a substituent; R¹³ represents a halogen atom, a nitro group, a cyano group, an alkoxycarbonyl group having 2 to 12 carbon atoms, or an acyl group having 2 to 12 carbon atoms; and R¹¹ and R¹² may be bonded to each other to form a ring.

16. An ink comprising:
the compound according to claim 1.

17. A toner comprising:
the compound according to claim 1.

18. A coloring resin composition comprising:
the compound according to claim 1.

19. A composition for dyeing a fiber, comprising:
the compound according to claim 1.

20. A compound represented by the following Formula (2), 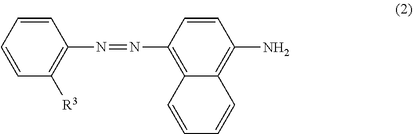
wherein, in the Formula (2), R³ represents a halogen atom, a nitro group, a cyano group, an alkoxycarbonyl group having 2 to 12 carbon atoms, or an acyl group having 2 to 12 carbon atoms.
